(19) United States
(12) Patent Application Publication
(10) Pub. No.: US 2016/0349636 A1
(43) Pub. Date: Dec. 1, 2016

(54) ELECTROPHOTOGRAPHIC TONER AND MANUFACTURING METHOD THEREOF, TONER CARTRIDGE AND IMAGE FORMING APPARATUS

(71) Applicants: KABUSHIKI KAISHA TOSHIBA, Tokyo (JP); TOSHIBA TEC KABUSHIKI KAISHA, Tokyo (JP)

(72) Inventors: Taishi Takano, Sunto-gun (JP); Maiko Yoshida, Mishima-shi (JP); Satoshi Araki, Mishima-shi (JP); Takashi Urabe, Sunto-gun (JP)

(21) Appl. No.: 15/231,927

(22) Filed: Aug. 9, 2016

Related U.S. Application Data
(62) Division of application No. 14/319,463, filed on Jun. 30, 2014.

(51) Int. Cl. G03G 9/08

(52) U.S. Cl. CPC G03G 9/0804

(57) ABSTRACT

The object of the present invention is to provide an electrophotographic toner hardly causing toner scattering and capable of achieving an adequate decorativeness, a manufacturing method thereof, a toner cartridge and an image forming apparatus. In accordance with an embodiment, the electrophotographic toner is a toner in which coloring agent particles are coated by resin. The volume mean diameter of the coloring agent particles is above 6 μm. The ratio (S/V) of the BET specific surface area S (m̂2/g) of the electrophotographic toner to the volume mean diameter V (μm) of the electrophotographic toner is above 0.015.

### CROSS-REFERENCE TO RELATED APPLICATIONS

This application is a Division of application Ser. No. 14/319,463 filed on Jun. 30, 2014, the entire contents of which are incorporated herein by reference.

### FIELD

Embodiments described herein relate generally to an electrophotographic toner and a manufacturing method thereof, a toner cartridge and an image forming apparatus.

### BACKGROUND

Demands of consumer for high value-added printing have been increasing in recent years. Among the high value-added printing, printed matters having glossiness and glittering feeling (decorative images) are in high demand.

It is known that with the use of an electrophotographic toner (hereinafter referred to as ‘toner’) containing a pigment with a large particle diameter as a coloring agent, a printed matter having a unique brightness can be obtained. However, if prepared the toner with the pigment having a large particle diameter using a pulverization method, the toner scattering occasionally occur because of the existence of a great many of particles of the simple substance of the pigment, particles having a large area of exposed pigment and particles containing no pigment in the toner caused by the unevenness of the particle sizes of the toner.

On the other hand, to prepare a toner having little simple substance particles of pigment or having a small area of exposed pigment, the amount of the resin added in the toner will be definitely increased, and the particle diameter of the toner will increase. Meanwhile, the orientation of the pigment on a substrate becomes incomplete, and sometimes a desired decorativeness is unachievable.

### BRIEF DESCRIPTION OF THE DRAWINGS

FIG. 1 is a diagram illustrating a method for manufacturing the electrophotographic toner according to an embodiment;

FIG. 2 is a diagram illustrating a coagulation step (Act 103′) according to an embodiment;

FIG. 3 is a diagram illustrating an image forming apparatus according to an embodiment;

FIG. 4 is a diagram illustrating the components of a toner according to different examples; and

FIG. 5 is a diagram illustrating the evaluation results obtained in different examples.

### DETAILED DESCRIPTION

The object of the present invention is to provide a hardly-scattering electrophotographic toner capable of achieving an adequate decorativeness, a manufacturing method thereof, a toner cartridge and an image forming apparatus.

### Embodiment 1

The electrophotographic toner according to embodiment 1 is a toner in which the coloring agent particles are coated by a resin.

The volume mean diameter of the coloring agent particles is above 6 μm.

The ratio (S/V) of the BET specific surface area S (m̂2/g) of the electrophotographic toner to the volume mean diameter V (μm) of the electrophotographic toner according to the present embodiment is above 0.015.

The electrophotographic toner according to the present embodiment is described below.

The electrophotographic toner according to the present embodiment is a toner in which coloring agent particles are coated by resin.

The volume mean diameter of the coloring agent particles is above 6 um. The use of the coloring agent particles having a volume mean diameter of above 6 μm in the toner guarantees the adequate decorativeness of the toner. Preferably, the volume mean diameter of the coloring agent particles is 6-100 μm. An adequate decorativeness is unachievable when the volume mean diameter of the coloring agent particles is below 6 μm while it is difficult to control the development and the transfer in an electrophotographic system when the volume mean diameter is above 100 μm. From the point of view of both control and decorativeness in an electrophotographic system, the volume mean diameter of the coloring agent particles is preferably 6-90 μm, and more preferably, is 6-60 μm.

In the description, the volume mean diameter of particles may be measured using a laser diffraction type particle size distribution analyzer.

The shape of the coloring agent particles, to which no limitations are given, may be tabular, columnar and spherical, and preferably tabular. If the shape of the coloring agent particles is tabular, then the coloring agent particles can easily be orientated parallel to an image plane during an image formation process, thereby achieving a better decorativeness easily.

The coloring agent constituting the coloring agent particles may be carbon black or an organic or inorganic pigment.

The carbon black may be acetylene black, furnace black, thermal black, channel black and Ketjen black.

The organic or inorganic pigment may be first yellow G, benzidine yellow, india first orange, irgazin red, carmine FB, permanent bold FRR, pigment orange R, lysol red 2G, lake red C, rhodamine FB, rhodamine B lake, phthalocyanine blue, pigment blue, brilliant green B, phthalocyanine green, quinacridone and a pearlescent pigment. The pearlescent pigment may be, for example, metal powder of aluminum, brass, bronze, nickel, stainless and zinc; a coated flaky inorganic crystal substrate such as mica coated with titanium oxide or yellow iron oxide, barium sulfate, layered silicate or layered aluminum silicate; monocrystal plate-like titanium oxide, basic carbonate, bismuth oxychloride, natural guanine, flaky glass powder and metal deposited flaky glass powder.

One kind of or the combination of two or more kinds of coloring agents may be used.

From the point of view of excellent decorativeness, it is preferable to use an organic or inorganic pigment in the coloring agent, and it is more preferable to use a pearlescent pigment.

The content of the coloring agent in the toner, with respect to the total amount (excluding the under-mentioned external additive) of the toner, is preferably 5-60 mass %, and more preferably, 15-50 mass %. Decorativeness is scarcely achieved when the content of the coloring agent is below a preferable lower limit value while the fixability and the fastness of an image are deteriorated when the content of the coloring agent is above a preferable upper limit value.

The resin used in the electrophotographic toner according to the present embodiment may be polyester resin, polystyrene resin, polyurethane resin and epoxy resin.

The polyester resin may be, for example, a condensation polymer which is polycondensated with an alcohol component the valence of which is greater than 2 and a carboxylic acid component the valence of which is greater than 2. The carboxylic acid component the valence of which is greater than 2 may be carboxylic acid, carboxylic acid anhydride or carboxylic acid ester, the valence of which is greater than 2. Preferably, the polyester resin is prepared by esterifying and polycondensating a diol component and a dicarboxylic acid component.

The diol component may be an aliphatic diol such as ethylene glycol, propylene glycol, 1,4-butanediol, 1, 3-butanediol, 1,5-pentanediol, 1,6-hexanediol, neopentyl glycol, trimethylene glycol, trimethylolpropane and pentaerythritol; an alicyclic diol such as 1,4-cyclohexanediol and 1,4-cyclohexanedimethyl; an ethylene oxide additive such as bisphenol A; or an propylene oxide additive. The dicarboxylic acid component may be an aromatic dicarboxylic acid such as terephthalic acid, phthalic acid and isophthalic acid; or an aliphatic carboxylic acid such as fumaric acid, maleic acid, succinic acid, adipic acid, sebacic acid, glutaric acid, pimelic acid, oxalic acid, malonic acid, citraconic acid and itaconic acid. The polyester resin may be amorphous or crystalline.

The polyester resin may be, for example, the polymer of a monomer of an aromatic vinyl component, the copolymer of the aromatic vinyl component and a diene component and the copolymer of the aromatic vinyl component and a (meth) acrylic ester component. (Meth) acrylic ester represents at least one of acrylic ester and methacrylic acid ester.

The aromatic vinyl component may be styrene, a-methylstyrene, o-methylstyrene and p-chlorostyrene. The diene component may be butadiene and isoprene. The (meth) acrylic ester component may be ethylacrylate, propyl acrylate, butylacrylate, 2-ethylhexyl acrylate, butylmethacrylate, ethyl methacrylate and methyl methacrylate. The polystyrene resin is generally polymerized using an emulsion polymerization method. The polystyrene resin is prepared by radically polymerizing monomers of each component in an emulsifier-containing aqueous phase.

The glass transition temperature of the resin which is properly determined according to a printing condition and the like is preferably 30-70 degrees centigrade.

The weight-average molecular weight (Mw) of the resin is preferably 5000-70000, and more preferably, 10000-30000. If the Mw of the resin is below a preferable lower limit value, then the heat-resistant preservability of the toner is degraded. On the other hand, the fixation temperature of the resin increases with the increase of the Mw of the resin. Thus, from the point of view of suppressing power consumption for a fixation processing, it is not preferable if the Mw of the resin is above a preferable upper limit value.

In the description, the weight-average molecular weight (Mw) of the resin is a converted value in terms of polystyrene by the gel permeation chromatography.

One kind of or the combination of two or more kinds of the resins may be used.

As the lower the glass transition temperature of the resin is, the better the low-temperature fixability of the resin is, the resin is preferably polyester resin and polystyrene resin, and more preferably, polyester resin. The polyester resin is preferably a polyester resin the acid value of which is 2-50 mgKOH/g.

The content of the resin in the toner, with respect to the total amount (excluding the under-mentioned external additive) of the toner, is preferably 30-60 mass %. If the content of the resin is below a lower limit value, it is difficult to guarantee the fixability and the fastness of an image. If the content of the resin is above a preferable upper limit value, fixability and decorativeness can hardly be guaranteed, besides, the toner is likely to scatter.

In addition to the coloring agent particles and the resin, the electrophotographic toner according to the present embodiment may further contain other components, if needed. The other components may include wax, a charge controlling agent, a surfactant, a basic compound, a coagulating agent, an external additive and a PH adjuster.

The wax may be an aliphatic hydrocarbon based wax including low molecular weight polyethylene, low molecular weight polypropylene, polyolefin copolymer, polyolefin wax, microcrystalline wax, paraffin wax and Fischer-Tropsch wax; oxides of an aliphatic hydrocarbon based wax such as polyethylene oxide wax; or the block copolymers thereof; a vegetable wax including candelilla wax, carnauba wax, Japan wax, jojoba wax and rice wax; an animal wax including bees wax, Lanolin and whale wax; a mineral wax including ozokerite, ceresin and petrolatum; an ester wax the main component of which is fatty acid ester, including palmitic acid ester wax, montanic acid ester wax and castor wax; and a wax the aliphatic ester of which is partially or totally deoxidized, including deoxidized carnauba wax.

One kind of or the combination of two or more kinds of the waxes may be used.

From the point of view of an excellent offset suppression effect, the wax is preferably an aliphatic hydrocarbon based wax and an ester wax the main component of which is fatty acid ester, and more preferably, paraffin wax and an ester wax the main component of which is palmitic acid ester.

The content of the wax in the toner, with respect to the total amount (excluding the under-mentioned external additive) of the toner, is preferably 3-30 mass %, and more preferably, 5-20 mass %. If the content of the wax is below a preferable lower limit value, then the offset property is insufficient and the fixability can hardly be guaranteed. If the content of the wax is above a preferable upper limit value, then filming occurs easily.

The charge controlling agent which controls the charge properties of the toner so that the toner can be easily transferred onto a recording medium may be a metal-containing azo compound, a metal-containing salicylic acid derivative and the like. The metal-containing azo compound is preferably the complex or the complex salt of metal Fe, cobalt or chromium or the mixture thereof. The metal-containing azo compound is preferably the complex or the complex salt of metal zirconium, zinc, chromium or boron or the mixture thereof.

The surfactant which mainly functions as a dispersant during the preparation of the toner may be an anionic surfactant including sulfuric acid ester salt, sulfonic acid salt, phosphoric ester salt, soap and carboxylate; a cationic surfactant including amine salt and quaternary ammonium salt; or a polyethylene glycol-based, alkylphenol ethylene oxide adduct-based or polyhydric alcohol-based nonionic surfactant.

The basic compound which mainly functions as a dispersing auxiliary during the preparation of the toner may be an amine compound which may be dimethylamine, trimethylamine, monoethylamine, diethylamine, triethylamine, propylamine, isopropylamine, dipropylamine, butylamine, isobutylamine, sec-butylamine, monoethanolamine, diethanolamine, triethanolamine, triisopropanolamine, isopropanolamine, dimethylethanolamine, diethylethanolamine, N-butyldiethanolamine, N,N-dimethyl-1,3-diaminopropane and N,N-diethyl-1,3-diaminopropane.

The coagulating agent which is optionally used to promote the coagulation of the coloring agent particles and fine resin particles or the coloring agent particles, fine resin particles and fine wax particles during the preparation of the toner may be a metal salt including sodium chloride, calcium chloride, calcium nitrate, barium chloride, magnesium chloride, zinc chloride, magnesium sulfate, aluminum chloride, aluminum sulfate and aluminum potassium sulfate; a nonmetal salt including ammonium chloride and ammonium sulfate; an inorganic metal salt polymer including polyaluminum chloride, polyaluminum hydroxide and calcium polysulfide; a high molecular coagulating agent including polymethacrylic ester, polyacrylic ester, polyacrylamide and acrylic amide acrylic acid soda copolymer; a coagulant including polyamine, polydiallyl ammonium halide, polydiallyl dialkyl ammonium halide, melamine formaldehyde condensate and dicyandiamide; alcohols including methanol, ethanol, 1-propanol, 2-propanol, 2-methyl-2-propanol, 2-methoxyethanol, 2-ethoxyethanol and 2-butoxyethanol; an organic solvent such as acetonitrile and 1,4-dioxane; an inorganic acid including hydrochloric acid and nitric acid; or an organic acid including formic acid and acetic acid. From the point of view of an excellent coagulation promotion effect, the coagulating agent is preferably a nonmetallic salt, and more preferably, ammonium sulfate.

To endow the toner with fluidity or to adjust the charge properties of the toner, the external additive may be inorganic fine particles composed of an inorganic substance which may be, for example, silica, titania, alumina, strontium titanate and tin oxide. One kind of or the combination of two or more kinds of the inorganic fine particles may be used. For the point of view of environmental stability, it is preferable to conduct a surface treatment on the inorganic fine particle with a hydrophobic agent. To improve cleaning properties, the external additive may be fine resin particles the particle diameter of which is below 1 μm. The resin constituting the fine resin particles may be, for example, styrene-acrylic acid copolymer, polymethyl methacrylate and melamine resin.

The electrophotographic toner according to the present embodiment is resin-coated coloring agent particles the volume mean diameter of which is above 6 μm.

In the description, ‘coloring agent particles being coated by resin’ refers to that more than 50% of the surface area of coloring agent particles is coated by resin. As to the electrophotographic toner according to the present embodiment, it is preferable that more than 90% of the surface area of the coloring agent particles is coated by the resin, and it is more preferable that 100% of the surface area of the coloring agent particles is coated by the resin. The confirmation on the coating of the coloring agent particles by the resin can be realized by observing the surface of a particle sample using a SEM (Scanning Electron Microscope) and then conducting an image processing or a surface element analysis.

The ratio (S/V) of the BET specific surface area S (m̂2/g) of the electrophotographic toner to the volume mean diameter V (μm) of the electrophotographic toner according to the present embodiment is above 0.015. An adequate decorativeness is achieved and the toner hardly scatters when the ratio (S/V) is above 0.015. The ratio (S/V) is preferably above 0.020, and more preferably, above 0.025. On the other hand, the ratio (S/V) is preferably below 1, more preferably, below 0.50, and further more preferably, below 0.30. The decorativeness is further improved if the ratio (S/V) is below a preferable upper limit value.

The volume mean diameter V (μm) of the electrophotographic toner according to the present embodiment is preferably 7-150 μm, more preferably, 10-100 μm, and further more preferably, 10-80 μm. The decorativeness can be easily achieved if the volume mean diameter of the electrophotographic toner is above a preferable lower limit value. The toner hardly scatters if the volume mean diameter of the electrophotographic toner is below a preferable upper limit value. Additionally, it becomes easy to control the development and transfer using electrophotography.

The BET specific surface area S (m̂2/g) of the electrophotographic toner is preferably 0.20-5.0 m̂2/g, more preferably, 0.50-4.0 m̂2/g, and further more preferably, 0.60-3.5 m̂2/g. The decorativeness can be easily achieved if the BET specific surface area of the electrophotographic toner is above a preferable lower limit value. The toner hardly scatters if the BET specific surface area of the electrophotographic toner is below a preferable upper limit value.

In the description, the BET specific surface area of particles can be measured using an automatic specific surface area and pore distribution measuring instrument which takes the gas adsorption method based on the Constant Volume Method as measurement method.

The ratio (S/V) of the electrophotographic toner can be controlled by selecting the particle size of the coloring agent, the method for preparing the toner or the method for mixing the coloring agent with the resin.

The electrophotographic toner according to embodiment 1 is a toner in which the coloring agent particles having a volume mean diameter of above 6 μm are coated by a resin and which contains few simple substance particles of a coloring agent, particles having a large area of exposed coloring agent or particles containing no coloring agent. Further, in the electrophotographic toner according to embodiment 1, a relatively large surface area is guaranteed with respect to the particle size of the toner. Thus, the toner has excellent charging properties in electrophotography. Consequentially, with the electrophotographic toner according to embodiment 1, an adequate decorativeness can be achieved and the toner hardly scatters.

The electrophotographic toner according to the present embodiment can be preferably used in a nonmagnetic one-component developing agent or a two-component developing agent. The toner can be carried in an image forming apparatus such as a MFP (Multi-function Peripheral) to form an image on a recording medium in an electrophotography manner. When the toner is used in a two-component developing agent, the carrier applicable is not limited specifically and can be properly selected by those of ordinary skill in the art.

### Embodiment 2

The electrophotographic toner manufacturing method described in embodiment 2 is a method for preparing the electrophotographic toner described in embodiment 1.

The electrophotographic toner manufacturing method described in embodiment 2 includes a first coagulation step which refers to a step of obtaining an aggregate by adding resin-containing resin dispersion (p1) to coloring agent dispersion.

The coloring agent dispersion contains coloring agent particles the volume mean diameter of which is above 6 μm.

The electrophotographic toner manufacturing method according to the present embodiment is described below with reference to the accompanying drawings.

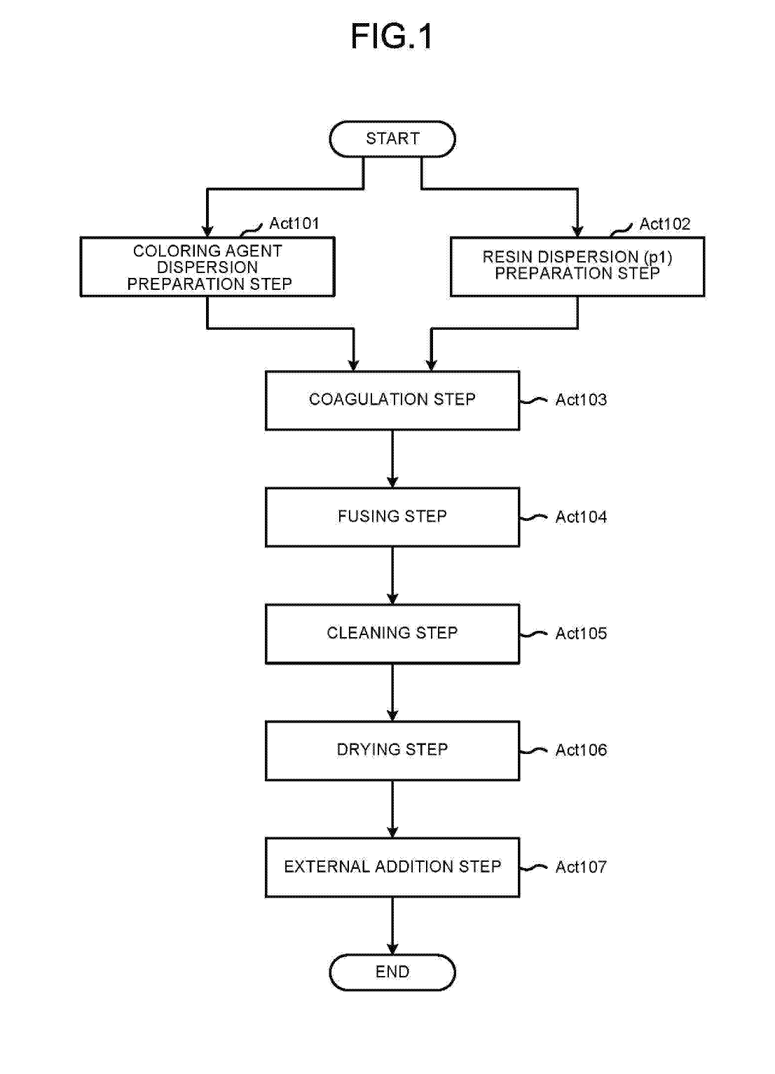

FIG. 1 is a diagram schematically illustrating the electrophotographic toner manufacturing method according to embodiment 2. The electrophotographic toner manufacturing method according to embodiment 2 includes: a coloring agent dispersion preparation step (Act 101), a resin dispersion (p1) preparation step (Act 102), a coagulation step (Act 103), a fusing step (Act 104), a cleaning step (Act 105), a drying step (Act 106) and an external addition step (Act 107).

The coloring agent particles, the resin and the other components combined using the manufacturing method according to embodiment 2 may be the same as the aforementioned coloring agent particles, resin and other components (wax, charge controlling agent, surfactant, basic compound, coagulating agent, external additive and PH adjuster).

The coloring agent dispersion preparation step (Act 101) is described below.

The coloring agent dispersion contains coloring agent particles the volume mean diameter of which is above 6 μm. The coloring agent dispersion is prepared in advance prior to the coagulation step (Act 101 in FIG. 1).

The dispersion medium in the coloring agent dispersion can be water or the mixture solvent of water and an organic solvent, and preferably water.

Apart from the coloring agent and the dispersion medium, the coloring agent dispersion may further contain other components, which may include a surfactant and a basic compound.

The coloring agent dispersion can be prepared by, for example, mixing the coloring agent, and other components, if needed, added in a dispersion medium with a mechanical shear force being applied to the dispersion medium liquid.

The mechanical shear device providing the mechanical shear force may be a mechanical shear device using no medium, including ULTRATURAX (produced by IKA Japan K.K.), T.K. AUTO HOMO MIXER (produced by PRIMIX Corporation), T.K. PIPELINE HOMO MIXER (produced by PRIMIX Corporation), T.K. FILMICS (produced by PRIMIX Corporation), CLEAR MIX (produced by MTECHNIQUE Co., Ltd.), CLEAR SS5 (produced by MTECHNIQUE Co., Ltd.), CAVITRON (produced by EUROTEC, Ltd.), FINE FLOW MILL (produced by Pacific Machinery & Engineering Co., Ltd.), micro fluidizer (produced by MIZUHO Industrial CO., LTD), Altimizer (produced by SUGINO MACHINE LIMITED), Nanomizer (produced by Yoshida Machinery Industry Co., Ltd.), genus PY (produced by Hakusui Chemical Industries, Ltd) and NANO 3000 (produced by Beryu Corporation); or a mechanical shear device using a medium, including VISCO MILL (produced by Aimex Co., Ltd.), APEX MILL (produced by Kotobuki Industries Co., Ltd.), STAR MILL (produced byAshizawa Finetech Ltd.), DCP SUPERFLOW (produced by Nippon Eirich Co., Ltd.), MP MILL (produced by Inoue Mfg., Inc.), SPIKE MILL (produced by Inoue Mfg., Inc.), MIGHTY MILL (produced by Inoue Mfg., Inc.) and SC MILL (produced by Mitsui Mining Company, Limited).

The volume mean diameter and the shape of the coloring agent particle can be controlled by adjusting the mechanical shear force of the mechanical share device.

The concentration of the coloring agent in the coloring agent dispersion, to which no specific limitations are given, is preferably 2-15 mass %.

The resin dispersion (p1) preparation step (Act 102) is described below.

The resin dispersion (p1) contains fine resin particles. The resin dispersion (p1) is prepared in advance prior to the coagulation step (Act 102 in FIG. 1).

The dispersion medium in the resin dispersion can be water or the mixture solvent of water and an organic solvent, and preferably, water.

Apart from the resin and the dispersion medium, the resin dispersion (p1)) may further contain other components, which may include a surfactant and a basic compound.

The resin dispersion (p1) can be prepared by, for example, mixing the resin, and other components, if needed, added in a dispersion medium with a mechanical shear force being applied to the dispersion medium liquid. Under the mechanical shear force, the resin can be atomized.

In the description, the atomization refers to a processing of decreasing the particle size of the particulate mixture in the dispersion with respect to the particle size available before the shear force is provided.

The mechanical shear device providing a mechanical shear force for atomizing the resin may be the same as that used in the preparation of the coloring agent dispersion.

The volume mean diameter of the fine resin particles contained in the resin dispersion (p1), to which no specific limitations are given, is preferably 0.05-0.30 μm. The shape of the fine resin particle, to which no specific limitations are given, may be spherical, columnar and tabular, and preferably spherical in view of the coagulation with the coloring agent particles.

The volume mean diameter and the shape of the fine resin particles can be controlled by adjusting the mechanical shear force of the mechanical share device.

The concentration of the resin in the resin dispersion (p1), which can be properly set according to the concentration of the coloring agent, is preferably 20-40 mass %.

The coagulation step (Act 103) is described below.

In the first coagulation step, the resin dispersion (p1) is added in the coloring agent dispersion so that the coloring agent dispersion particles and the fine resin particles are hetero-coagulated to obtain an aggregate in which the surface of the coloring agent particles is coated by the fine resin particles. Further, in the description, hetero-coagulation refers to the coagulation of fine resin particles or fine wax particles in coloring agent particles.

The first coagulation step can be carried out in an ordinary coagulation reactor. The reaction volume can be properly set within a range from a laboratory scale to an industrial scale.

When added to the coloring agent dispersion, the resin dispersion (p1) is preferably added for a long time every time in a small amount with respect to the total amount of the coloring agent dispersion. The resin dispersion (p1) can be added continuously or intermittently in a specified amount, and it is preferable that the resin dispersion (p1) is added continuously in a specified amount. The continuous addition facilitates the hetero-coagulation of the coloring agent particles and the fine resin particles as well as the manufacturing of the toner the ratio (S/V) of which is above 0.015 and the obtaining of an aggregate in which the surface of coloring agent particles is totally coated by fine resin particles. In the case of the continuous addition of the resin dispersion (p1), it is preferable that the resin dispersion (p1) is added to the coloring agent dispersion at a fixed addition speed which is properly determined according to a combination scale.

When the resin dispersion (p1) is added to the coloring agent dispersion, an optional component can be added as well, if needed. The optical component may be a coagulating agent or a charge controlling agent.

The fusing step (Act 103) is described below.

In the present embodiment, the fusing step is a step of heating the aggregate obtained in the coagulation step. Thus, the coloring agent particles and the fine resin particles constituting the aggregate are fused to obtain fused particles. The fusing step can be carried out in synchronization with the coagulation step.

The heating temperature of the aggregate which can be set properly is preferably below a temperature which is 40 degrees centigrade higher than the glass transition temperature of the fine resin particles, but above the glass transition temperature of the fine resin particles. The heating time is preferably 2-10 hours.

The volume mean diameter of the fused particles resulting from the fusing step is preferably 7-150 μm, and more preferably, 10-100 μm.

The cleaning step (Act 105) is described below.

In the present embodiment, the cleaning step is a step of cleaning the fused particles obtained in the fusing step. The cleaning step can be properly carried out using a well-known cleaning method. For example, the cleaning step can be carried out by repeatedly cleaning and filtering the fused particles with ion exchange water. It is preferable that the cleaning step is carried out repeatedly until the conductivity of the filtrate is below 50 is/cm.

The drying step (Act 106) is described below.

In the present embodiment, the drying step is a step of drying the fused particles cleaned in the cleaning step. The drying step can be properly carried out using a well-known drying method. For example, the drying step can be carried out using a vacuum dryer. It is preferable that the drying step is carried out until the water content of the fused particles is, for example, below 1.0 mass %.

The external additive step (Act 107) is described below.

In the present embodiment, the external additive step is a step of adding an external additive to the fused particles dried in the drying step.

The external additive can be optionally added to endow the toner with fluidity or to adjust charge properties or to improve cleaning properties.

In the electrophotographic toner manufacturing method according to embodiment 2, in the coagulation step, the resin dispersion is added to the coloring agent dispersion to obtain an aggregate (first coagulation step). The coloring agent particles the volume mean diameter of which is above 6 μm is totally coated by the resin in the first coagulation step. Further, the coloring agent particles of the toner prepared using the manufacturing method is not pulverized but maintained in particle size (volume mean diameter is above 6 μm) and shape. Thus, by using the manufacturing method, a toner the ratio (S/V) of which is above 0.015 can be prepared easily. Consequentially, the prepared toner has a relatively large surface area with respect to the particle size thereof and therefore has an excellent charging performance in electrophotography and can be easily oriented parallel to an image plane. Thus, the electrophotographic toner manufactured using the manufacturing method according to the present embodiment can be used to form a high decorative image and hardly scatter.

Further, the coloring agent particles and the fine resin particles are hetero-coagulated easily. As a result, it is difficult to form an aggregate containing no coloring agent particles. Thus, the manufactured toner contains few simple substance particles of the coloring agent, few particles having a large area of exposed coloring agent and few particles containing no coloring agent, and an adequate decorativeness can be achieved easily.

### Embodiment 3

The electrophotographic toner manufacturing method according to embodiment 3 includes: a coloring agent dispersion preparation step (Act 101), a resin dispersion preparation step (Act 102), a coagulation step (Act 103°), a fusing step (Act 104), a cleaning step (Act 105), a drying step (Act 106) and an external addition step (Act 107).

The description of each step carried out in embodiment 3 except the coagulation step (Act 103′) is the same as that of a corresponding step carried out in embodiment 2.

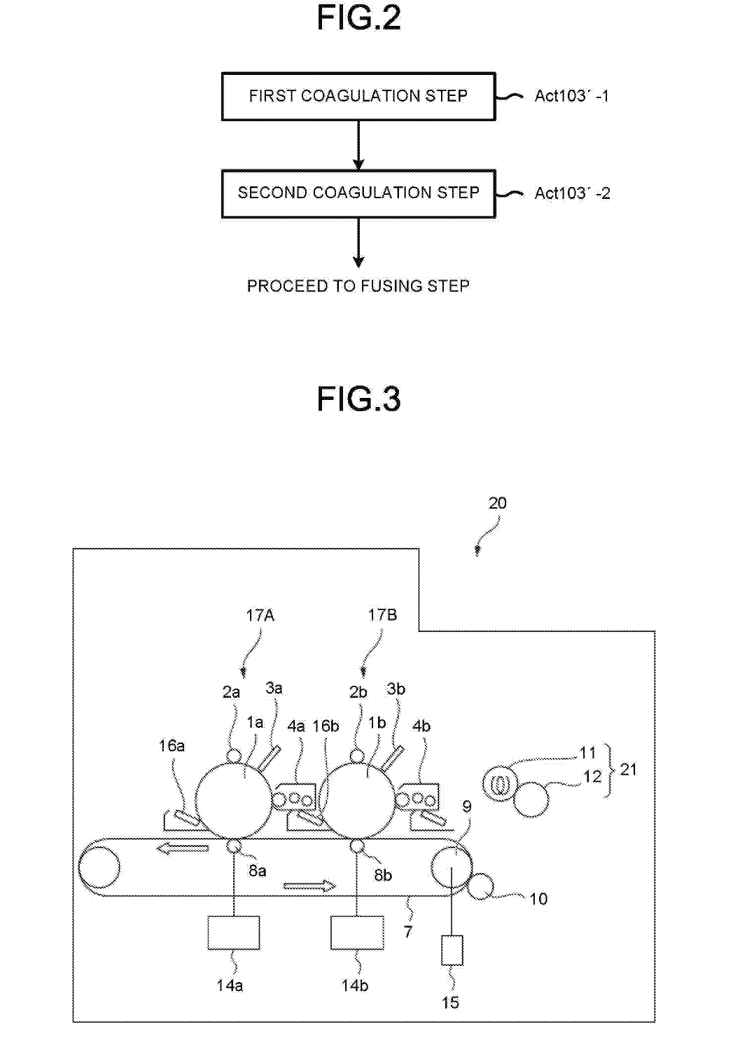

FIG. 2 is a diagram illustrating an embodiment of the coagulation step (Act 103′).

In the present embodiment, the coagulation step (Act 103′) includes a first coagulation step (Act 103′-1) and a second coagulation step (Act 103′-2).

The first coagulation step (Act 103′-1) is described below.

The description of the first coagulation step (Act 103T-1) is the same as that of the coagulation step (Act 103) carried out in embodiment 2.

The second coagulation step (Act 103′-2) is described below.

In the second coagulation step, a resin-containing resin dispersion (p2) is added after the first coagulation step to obtain an aggregate in which the surface of the aggregate obtained in the first coagulation step is coated by the fine resin particles in the resin dispersion (p2). Along with this, a toner is obtained more easily which contains few simple substance particles of coloring agent or particles having a little area of exposed coloring agent.

The resin dispersion (p2) contains fine resin particles. The resin contained in the resin dispersion (p2) may be the same as or different from that in the resin dispersion (p1).

The dispersion medium in the resin dispersion (p2) can be water or the mixture solvent of water and an organic solvent, and preferably, water.

Apart from the resin and the dispersion medium, the resin dispersion (p2) may further contain other component which may include a surfactant and a basic compound.

The resin dispersion (p2) may be prepared in the way the resin dispersion (p1) is prepared.

The volume mean diameter of the fine resin particles contained in the resin dispersion (p2), to which no specific limitations are given, is preferably 0.05-0.30 μm. The shape of the fine resin particle, to which no specific limitations are given, may be spherical, columnar and tabular, and preferably, spherical for the sake of facilitating the coagulation with the aggregate obtained in the first coagulation step.

The concentration of the resin in the resin dispersion (p2), which can be properly set according to the components of the aggregate, is preferably 10-40 mass %.

When added to a dispersion containing the aggregate obtained in the first coagulation step, the resin dispersion (p2) may be added continuously or intermittently in a specified amount. It is preferable that the resin dispersion (p2) is added continuously in a specified amount. In this way, an aggregate in which the surface of the aggregate obtained in the first coagulation step is coated by the fine resin particles contained in the resin dispersion (p2) can be obtained easily. In the case of the continuous addition of the resin dispersion (p2), it is preferable that the resin dispersion (p2) is added to the coloring agent dispersion at a fixed addition speed which is properly determined according to a combination scale.

The amount of the resin added in the second coagulation step, to which no specific limitations are given, may be properly determined in consideration of the amount of the other components added and is preferably 10-50 mass % of the total amount of the resin added. The total amount of the resin added refers to the total amount of the resin combined in the manufacturing of the toner.

Optional components, if needed, can be added when the resin dispersion (p2) is added to a dispersion containing the aggregate obtained in the first coagulation step. The optical component may include a coagulating agent and a charge controlling agent.

In the electrophotographic toner manufacturing method according to embodiment 3, the resin dispersion (p2) is further added to the dispersion containing the aggregate obtained in the first coagulation step to obtain an aggregate (second coagulation step). In other words, the aggregate resulting from the hetero-coagulation in the first coagulation step is further coated by fine resin particles. Thus, an aggregate can be indeed obtained in which the surface of coloring agent particles is totally coated by fine resin particles. Thus, a toner is manufactured which contains few simple substance particles of coloring agent, few particles having a large area of exposed coloring agent and few particles containing no coloring agent, and an image having a better decorativeness can be obtained.

In the electrophotographic toner manufacturing method according to embodiment 2 or 3, wax, if combined as an optional component, is preferably combined by adding a wax dispersion in the first coagulation step so that more fine wax particles can adhere to coloring agent particles easily.

The wax dispersion contains fine wax particles. The wax dispersion is prepared in advance prior to the coagulation step. The dispersion medium in the wax dispersion can be water and the mixture solvent of water and an organic solvent, and preferably, water. Apart from wax and the dispersion medium, the wax dispersion may further contain other components, which may include a surfactant and a basic compound.

The wax dispersion can be prepared by, for example, mixing wax, and other components, if needed, added in the dispersion medium with the dispersion medium liquid using a mechanical shear force. Under the mechanical shear force, wax is atomized.

The mechanical shear device providing a mechanical shear force for atomizing wax may be the same as the one used in the preparation of the coloring agent dispersion.

The volume mean diameter of the fine wax particles contained in the wax dispersion, to which no specific limitations are given, is preferably 0.05-0.30 μm. The shape of the fine wax particle, to which no specific limitations are given, may be spherical, columnar, tabular, and preferably spherical in view of the coagulation with the coloring agent particles along with the fine resin particles.

The volume mean diameter and the shape of the fine wax particles can be controlled by adjusting the mechanical shear force of the mechanical share device.

The concentration of the wax in the wax dispersion, which can be properly set according to the concentration of the coloring agent or the type of the resin, is preferably 30-50 mass %.

As a way of adding the wax dispersion, the wax dispersion may be added to the coloring agent dispersion in synchronization with the resin dispersion, or it is preferably that the wax dispersion is added after the resin dispersion is added to the coloring agent dispersion. By adding the wax dispersion in this order, more fine wax particles adhere to the coloring agent particles easily. Further, the configuration of the wax in the toner can be controlled. Thus, it is easy to manufacture an electrophotographic toner less liable to cause fuzziness or offset.

When added synchronously, the resin dispersion and the wax dispersion may be mixed in advance and then added as a mixture or added separately.

In the mixture of the resin dispersion and the wax dispersion, the ratio (mass %) of the resin to the wax is preferably 5:1-1:3.

If the resin dispersion and the wax dispersion are added in sequence, the wax dispersion may be added continuously or intermittently after the resin dispersion is added.

When added to the coloring agent dispersion, the resin dispersion, the wax dispersion or the mixture thereof (another dispersion or mixture liquid) are preferably added for a long time every time in a small amount with respect to the total amount of the coloring agent dispersion. The another dispersion or mixture liquid can be added continuously or intermittently in a specified amount. It is preferable that the resin dispersion, the wax dispersion or the mixture thereof is added continuously in a specified amount. The continuous addition facilitates the hetero-coagulation of the coloring agent particles, the fine resin particles and the fine wax particles as well as the obtaining of an aggregate in which the surface of coloring agent particles is totally coated by fine resin particles and fine wax particles. In the case of the continuous addition, it is preferable that the resin dispersion, the wax dispersion or the mixture thereof is added to the coloring agent dispersion at a fixed addition speed which is properly determined according to a combination scale.

### Embodiment 4

According to embodiment 4, a toner cartridge is formed by accommodating the electrophotographic toner described in embodiment 1 in a container which may be a well-known one.

By printing using the toner cartridge according to embodiment 4, a high decorative image can be obtained and an image in which a toner hardly scatters and which has no fuzziness can be formed.

### Embodiment 5

According to embodiment 5, an image forming apparatus is formed by accommodating the electrophotographic toner described in embodiment 1 in an apparatus body which may be an ordinary electrophotographic apparatus.

FIG. 3 is a pattern diagram schematically illustrating an example of an image forming apparatus according to embodiment 5.

As shown in FIG. 3, an image forming apparatus 20 comprises an apparatus body. The apparatus body comprises an intermediate transfer belt 7, a first image forming unit 17A and a second image forming unit 17B orderly arranged on the intermediate transfer belt 7 and a fixing device 21 arranged at the downstream side of the first image forming unit 17A and the second image forming unit 17B. Along the movement direction of the intermediate transfer belt 7, that is, along the direction of the performing of an image forming process, the first image forming unit 17A is at the downstream side of the second image forming unit 17B.

The first image forming unit 17A comprises a photoconductive drum 1a, a cleaning device 16a, a charging device 2a and an exposure device 3a which are orderly arranged on the photoconductive drum 1a, a first developing device 4a and a primary transfer roller 8a arranged opposite to the photoconductive drum 1a across the intermediate transfer belt 7.

The second image forming unit 17B comprises a photoconductive drum 1b, a cleaning device 16b, a charging device 2b and an exposure device 3b which are successively arranged on the photoconductive drum 1b, a second developing device 4b and a primary transfer roller 8b arranged opposite to the photoconductive drum 1b across the intermediate transfer belt 7.

The electrophotographic toner described in embodiment 1 is accommodated in the first developing device 4a and the second developing device 4b. The electrophotographic toner may be fed from a toner cartridge (not shown).

The primary transfer rollers 8a and 8b are connected with primary transfer power supplies 14a and 14b, respectively.

A secondary transfer roller 9 and a backup roller 10 are arranged opposite to each other across the intermediate transfer belt 7 at the downstream side of the second image forming unit 17B. The secondary transfer roller 9 is connected with a secondary transfer power supply 15.

The fixing device 21 is provided with a heat roller 11 and an opposite press roller 12 which are arranged opposite to each other.

An image can be formed in the following way using the image forming apparatus 20 shown in FIG. 3.

First, the photoconductive drum 1b is uniformly charged by the charging device 2b.

Next, the photoconductive drum 1b is exposed by the exposure device 3b to form an electrostatic latent image. Then, the electrostatic latent image is developed using the toner fed from the developing device 4b to obtain a second toner image.

Sequentially, the photoconductive drum 1a is uniformly charged by the charging device 2a.

Then, the photoconductive drum 1a is exposed by the exposure device 3a based on first image information (the second toner image) to form an electrostatic latent image. Next, the electrostatic latent image is developed using the toner fed from the developing device 4a to obtain a first toner image.

The second toner image and the first toner image are successively transferred onto the intermediate transfer belt 7 using the primary transfer rollers 8a and 8b.

The images laminated on the intermediate transfer belt 7 in the order of the second toner image and the first toner image are secondarily transferred onto a recording medium (not shown) using the secondary transfer roller 9 and the backup roller 10, thereby forming images on the recording medium laminated in the order of the first toner image and the second toner image.

The type of the coloring agent used by the toner in the developing device 4a or 4b can be selected optionally. The image forming apparatus 20 shown in FIG. 3, although equipped with two developing devices, may have three or more developing devices according to the types of the toners used.

With the use of the image forming apparatus according to embodiment 5, a high decorative image can be obtained and an image in which a toner hardly scatters and which has no fuzziness can be formed.

According to at least one of the embodiments described above, a toner can be used in which coloring agent particles having a volume mean diameter of above 6 μm are coated by resin and the ratio (S/V) of the BET specific surface area S (m̂2/g) to the volume mean diameter (μm) of which is above 0.015. The toner has a large surface with respect to the particle size thereof and therefore has an excellent charge performance in electrophotography. Thus, an adequate decorativeness can be achieved when an image is formed with the toner. Besides, the toner hardly scatters in an image forming apparatus.

The following examples exemplify the embodiments which are, however, not limited to the examples.

The evaluation on the scattering of the toner is described below.

The toner manufactured in each embodiment is mixed with a ferrite carrier coated with silicon resin to serve as a developing agent. In this case, the concentration of the ferrite carrier in the developing agent is set so that the toner ratio concentration is 8 mass %.

A toner cartridge in which the developing agent is accommodated is arranged in an electrophotographic MFP (e-studio 2050c) produced by Toshiba Tec Corporation to carry out a continuous printing test. The running of the electrophotographic MET is stopped when a development operation is carried out in the continuous printing test. Next, the scattering of the toner is evaluated by visually confirming the scattering condition of the toner on the photoconductive drum. The evaluation standard for the scattering of the toner is as follows:

O: although the toner scatters onto the photoconductive drum, no substantial problem is caused.

X: the scattering of the toner on one side of the photoconductive drum is apparent, causing a substantial problem.

The evaluation on decorativeness is described below.

A developing agent is prepared in the way the developing agent used in the evaluation on the scattering of a toner is prepared.

A toner cartridge in which the developing agent is accommodated is arranged in an electrophotographic MET (e-studio 2050c) produced by Toshiba Tec Corporation. Then, a patch image is printed on a piece of black paper at a set fixing temperature of 150 degrees centigrade. Sequentially, the decorativeness of the fixed image is visually evaluated. The evaluation standard for the decorativeness is as follows:

O: the patch image is printed clearly, and an adequate decorativeness is achieved.

X: the patch image is severely uneven and the decorativeness achieved is poor.

The results of the evaluation on the scattering of the toner and the evaluation on the decorativeness are determined in the following way and shown in a table. That is, the final result is determined as O if the results of the both evaluations are O or as X if at least one of the evaluations is X.

The preparation of coloring agent dispersion A is described below.

7 parts by mass of cyan pigment (copper phthalocyanine pigment) serving as coloring agent, 0.1 part by mass of sodium dodecylbenzenesulfonate serving as anionic surfactant, 0.1 part by mass of triethylamine serving as amine compound and 92.8 parts by mass of ion exchange water are mixed in a CLEAR MIX to prepare a mixture. The temperature of the mixture is adjusted to 30 degrees centigrade in the CLEAR MIX. Then, a 10-minute mechanical shearing is carried out while the rotation speed of the CLEAR MIX is set to be 300 rpm to obtain the coloring agent dispersion A. When measured using SALD-7000 (produced by Shimadzu Corporation), the volume mean diameter (50% D) of the coloring agent particles in the coloring agent dispersion A is 95 μm.

The preparation of a coloring agent dispersion B is described below.

The coloring agent dispersion B is prepared in the way the coloring agent dispersion A is prepared except for that the rotation speed of the CLEAR MIX is set to be 1500 rmp. When measured using SALD-7000 (produced by Shimadzu Corporation), the volume mean diameter (50% D) of the coloring agent particles in the coloring agent dispersion B is 6 μm.

The preparation of resin dispersion is described below.

The resin used is polyester resin (acid value: 10 mgKOH/g, Mw 15000, Tg 58 degrees centigrade) resulting from the polycondensation of terephthalic acid and ethylene glycol.

30 parts by mass of the polyester resin, 1 part by mass of sodium dodecylbenzenesulfonate (NEOPELEX G15, produced by Kao Corporation) serving as anionic surfactant and 69 parts by mass of ion exchange water are mixed and then prepared into a dispersion having a pH of 12 using potassium hydroxide. The dispersion is fed into a high-pressure homogenizer NANO 3000 (produced by Beryu Corporation) to be mechanically sheared for 15 minutes at the temperature of 150 degrees centigrade at 150 MPa. The mixture subjected to the mechanical shearing is cooled to normal temperature to obtain the resin dispersion. When measured using SALD-7000 (produced by Shimadzu Corporation), the volume mean diameter (50% D) of the fine resin particles in the resin dispersion is 0.23 μm. The sharp particle size distribution of the resin dispersion is in accordance with a standard deviation of 0.15.

The preparation of wax dispersion is described below.

The wax used is an ester wax the main component of which is palmitic acid (C₁₆H₃₂O₂).

40 parts by mass of the ester wax, 4 parts by mass of sodium dodecylbenzenesulfonate serving as anionic surfactant, 1 part by mass of triethylamine serving as amine compound and 55 parts by mass of ion exchange water are mixed in a CLEAR MIX to prepare a mixture. The temperature of the mixture is heated to 80 degrees centigrade in the CLEAR MIX. Then, a 30-minute mechanical shearing is performed while the rotation speed of the CLEAR MIX is set to be 6000 rpm. The mixture subjected to the mechanical shearing is cooled to normal temperature to obtain the wax dispersion. When measured using SALD-7000 (produced by Shimadzu Corporation), the volume mean diameter (50% D) of the fine wax particles in the wax dispersion is 0.20 μm.

The preparation of the mixture A of the resin dispersion and the wax dispersion is described below.

35 parts by mass of the resin dispersion, 26 parts by mass of the wax dispersion and 39 parts by mass of ion exchange water are put in a flask and stirred to obtain the mixture A.

### Example 1

parts by mass of Iriodin 153 (produced by Merck Corporation and having a volume mean diameter of 51 μm) serving as a pearlescent pigment having a big particle size and 186 parts by mass of ion exchange water are mixed and stirred while 7 parts by mass of 0.5 mass % polydiallyl dimethyl ammonium chloride solution are added. The mixture is heated to 45 degrees centigrade and sequentially added with 30 parts by mass of 30 mass % ammonium sulfate solution and kept for 1 hour. Then the mixture solution of 60 parts by mass of the resin dispersion and 50 parts by mass of ion exchange water is slowly and continuously added for 10 hours to obtain a dispersion containing a first aggregate (first coagulation step).

Next, serving as surfactant, 5 parts by mass of a polycarboxylic acid-based surfactant (POIZ520, produced by Kao Corporation) are added into the dispersion containing the first aggregate. The dispersion is heated to 65 degrees centigrade and placed to be fused (fusing step).

Then, the dispersion containing the fused particles is repeatedly filtered and cleaned with ion exchange water until the conductivity of the filtrate is 50 μs/cm (cleaning step).

Sequentially, the fused particles separated after the final filtering operation is dried using a vacuum dryer until the water content of the particles is below 1.0 mass % to obtain a dried toner (drying step).

When measured using SALD-7000 (produced by Shimadzu Corporation), the volume mean diameter (50% D) of the dried toner is 72.0 μm. When measured using TriStar 3000 (produced by Shimadzu Corporation), the BET specific surface area of the dried toner is 1.79 m̂2/g.

Then, 2 parts by mass of hydrophobic silica and 0.5 part by mass of titanium oxide are added in the dried toner and then mixed with a Henschel mixer (external addition step).

The toner of example 1 is obtained through the operation above. The finally obtained toner has a volume mean diameter (50% D) of 72.0 μm and a BET specific surface area of 1.79 m̂2/g.

### Example 2

12 parts by mass of Iriodin 120 (produced by Merck Corporation and having a volume mean diameter of 14 μm) serving as a pearlescent pigment having a big particle size and 178 parts by mass of ion exchange water are mixed and stirred while 15 parts by mass of 0.5 mass % polydiallyl dimethyl ammonium chloride solution are added. The mixture is heated to 45 degrees centigrade and sequentially added with 30 parts by mass of 30 mass % ammonium sulfate solution and kept for 1 hour. At this time, the mixture solution of 60 parts by mass of the resin dispersion and 50 parts by mass of ion exchange water is slowly and continuously added for 10 hours to obtain a dispersion containing a first aggregate (first coagulation step).

Next, 5 parts by mass of a polycarboxylic acid-based surfactant (POIZ520, produced by Kao Corporation) serving as a surfactant is added to the dispersion containing the first aggregate. Then, the dispersion is heated to 65 degrees centigrade and placed to be fused (fusing step).

Then, the dispersion containing the fused particles is repeatedly filtered and cleaned with ion exchange water until the conductivity of the filtrate is 50 μs/cm (cleaning step).

Sequentially, the fused particles separated after the final filtering operation is dried using a vacuum dryer until the water content of the particles is below 1.0 mass % to obtain a dried toner (drying step).

When measured using SALD-7000 (produced by Shimadzu Corporation), the volume mean diameter (50% D) of the dried toner is 29.6 μm. When measured using TriStar 3000 (produced by Shimadzu Corporation), the BET specific surface area of the dried toner is 2.30 m̂2/g.

Then, 2 parts by mass of hydrophobic silica and 0.5 parts by mass of titanium oxide are added in the dried toner and then mixed with a Henschel mixer (external addition step).

The toner of example 2 is obtained through the operation above. The finally obtained toner has a volume mean diameter (50% D) of 29.6 μm and a BET specific surface area of 2.30 m̂2/g.

### Example 3

12 parts by mass of Iriodin 120 (produced by Merck Corporation and having a volume mean diameter of 14 μm) serving as a pearlescent pigment having a big particle size and 178 parts by mass of ion exchange water are mixed and stirred while 15 parts by mass of 0.5 mass % polydiallyl dimethyl ammonium chloride solution is added. The mixture is heated to 45 degrees centigrade and sequentially added with 30 parts by mass of 5 mass % ammonium sulfate solution and kept for 1 hour.

At this time, 29 parts by mass of the mixture A (the mixture of the resin dispersion and the wax dispersion) are dropped (continuously added) using a dropping funnel and then added with 7.5 parts by mass of 30% ammonium sulfate solution. In this way, the resin dispersion and the wax dispersion are synchronously added to a coloring agent dispersion to obtain a dispersion containing a first aggregate (first coagulation step).

Next, 18 parts by mass of 30% ammonium sulfate solution are added in the dispersion containing the first aggregate, at this time, the mixture solution of 40 parts by mass of the resin dispersion and 33 parts by mass of ion exchange water is continuously and mixed for 10 hours to obtain a dispersion containing a second aggregate (second coagulation step).

Next, serving as surfactant, 5 parts by mass of a polycarboxylic acid-based surfactant (POIZ520, produced by Kao Corporation) are added to the dispersion containing the second aggregate. The dispersion is heated to 65 degrees centigrade and placed to be fused (fusing step).

Then, the dispersion containing the fused particles is repeatedly filtered and cleaned with ion exchange water until the conductivity of the filtrate is 50 μs/cm (cleaning step).

Sequentially, the fused particles separated after the final filtering operation is dried using a vacuum dryer until the water content of the particles is below 1.0 mass % to obtain a dried toner (drying step).

When measured using SALD-7000 (produced by Shimadzu Corporation), the volume mean diameter (50% D) of the dried toner is 31.2 μm. When measured using TriStar 3000 (produced by Shimadzu Corporation), the BET specific surface area of the dried toner is 3.19 m̂2/g.

Then, 2 parts by mass of hydrophobic silica and 0.5 parts by mass of titanium oxide are added in the dried toner and then mixed with a Henschel mixer (external addition step).

The toner described in example 3 is obtained through the operation above. The finally obtained toner has a volume mean diameter (50% D) of 31.2 μm and a BET specific surface area of 3.19 m̂2/g.

### Example 4

150 parts by mass of the coloring agent dispersion B are put into a flask and stirred while 23 parts by mass of the mixture A are dropped using a dropping funnel (continuously added), and 3 parts by mass of 10 mass % ammonium sulfate solution are added. In this way, the resin dispersion and the wax dispersion are synchronously added to a coloring agent dispersion to obtain a dispersion containing a first aggregate (first coagulation step).

Next, 5 parts by mass of 10 mass % ammonium sulfate solution are added in and mixed with the dispersion containing the first aggregate, at this time, 50 parts by mass of the resin dispersion are slowly and continuously added for 10 hours to obtain a dispersion containing a second aggregate (second coagulation step).

The dispersion containing the second aggregate is heated to 65 degrees centigrade and placed to be fused (fusing step). When measured using SALD-7000 (produced by Shimadzu Corporation), the volume mean diameter (50% D) of the fused particles in the dispersion is 12.5 μm. When measured using TriStar 7000 (produced by Shimadzu Corporation), the BET specific surface area of the fused particles in the dispersion is 0.70 m̂2/g.

Then, the dispersion containing the fused particles is repeatedly filtered and cleaned with ion exchange water until the conductivity of the filtrate is 50 μs/cm (cleaning step).

Sequentially, the fused particles separated after the final filtering operation is dried using a vacuum dryer until the water content of the particles is below 1.0 mass % to obtain a dried toner (drying step).

Then, 2 parts by mass of hydrophobic silica and 0.5 parts by mass of titanium oxide are added in the dried toner and then mixed with a Henschel mixer (external addition step).

The toner described in example 4 is obtained through the operation above. The finally obtained toner has a volume mean diameter (50% D) of 12.5 μm and a BET specific surface area of 0.70 m̂2/g.

### Comparative Example 1

40 parts by mass of Iriodin 120 (produced by Merck Corporation and having a volume mean diameter of 14 μm) serving as a pearlescent pigment having a big particle size, 50 parts by mass of the polyester resin (acid value: 10 mgKOH/g, Mw 15000, Tg 58 degrees centigrade) and 10 parts by mass of an ester wax are put in a Henschel mixer and then mixed. Then, the mixture is fused and kneaded in a two-shaft screw kneader at 120 degrees centigrade to obtain a kneading object. The kneading object is consequentially coarsely pulverized with a Feather mill and pulverized with a jet mill. Sequentially, the milled object is classified using a rotor type classifier.

When measured using SALD-7000 (produced by Shimadzu Corporation), the volume mean diameter (50% D) of the classified toner is 33.8 μm. When measured using TriStar 3000 (produced by Shimadzu Corporation), the BET specific surface area of the classified toner is 0.43 m̂2/g.

Then, 2 parts by mass of hydrophobic silica and 0.5 parts by mass of titanium oxide are added in the classified and dried toner and then mixed with a Henschel mixer (external addition step).

The toner of comparative example 1 is obtained through the operation above. The finally obtained toner has a volume mean diameter (50% D) of 33.8 μm and a BET specific surface area of 0.43 m̂2/g.

### Comparative Example 2

12 parts by mass of iriodin 153 (produced by Merck Corporation and having a volume mean diameter of 51 μm) serving as a pearlescent pigment having a big particle size and 186 parts by mass of ion exchange water are mixed and stirred while 7 parts by mass of 0.5 mass % polydiallyl dimethyl ammonium chloride solution are added. Then, the mixture is added with 30 parts by mass of 30 mass % ammonium sulfate solution and kept for 1 hour. At this time, the mixture solution of 60 parts by mass of the resin dispersion and 50 parts by mass of ion exchange water is wholly added and heated to 45 degrees centigrade to obtain a dispersion containing a first aggregate (first coagulation step).

Next, serving as surfactant, 5 parts by mass of a polycarboxylic acid-based surfactant (POIZ520, produced by Kao Corporation) are added in the dispersion containing the first aggregate. The dispersion is heated to 65 degrees centigrade and placed to be fused (fusing step).

Then, the dispersion containing the fused particles is repeatedly filtered and cleaned with ion exchange water until the conductivity of the filtrate is 50 μs/cm (cleaning step).

Sequentially, the fused particles separated after the final filtering operation is dried using a vacuum dryer until the water content of the particles is below 1.0 mass % to obtain a dried toner (drying step).

When measured using SALD-7000 (produced by Shimadzu Corporation), the volume mean diameter (50% D) of the dried toner is 75.1 μm. When measured using TriStar 3000 (produced by Shimadzu Corporation), the BET specific surface area of the dried toner is 0.25 m̂2/g.

Then, 2 parts by mass of hydrophobic silica and 0.5 parts by mass of titanium oxide are added in the dried toner and then mixed with a Henschel mixer (external addition step).

The toner of comparative example 2 is obtained through the operation above. The finally obtained toner has a volume mean diameter (50% D) of 75.1 μm and a BET specific surface area of 0.25 m̂2/g.

### Comparative Example 3

150 parts by mass of the coloring agent dispersion A are put into a flask and stirred while 23 parts by mass of the mixture A are dropped using a dropping funnel (continuously added), and 3 parts by mass of 10 mass % ammonium sulfate solution are added. In this way, the resin dispersion and the wax dispersion are synchronously added in a coloring agent dispersion to obtain a dispersion containing a first aggregate (first coagulation step).

Next, 5 parts by mass of 10 mass % ammonium sulfate solution are added in and mixed with the dispersion containing the first aggregate, at this time, 50 parts by mass of the resin dispersion are slowly and continuously added for 10 hours to obtain a dispersion containing a second aggregate (second coagulation step).

Next, the dispersion containing the second aggregate is heated to 65 degrees centigrade and placed to be fused (fusing step). When measured using SALD-7000 (produced by Shimadzu Corporation), the volume mean diameter (50% D) of the fused particles in the dispersion is 115 μm. When measured using TriStar 7000 (produced by Shimadzu Corporation), the BET specific surface area of the fused particles in the dispersion is 0.13 m̂2/g.

Then, the dispersion containing the fused particles is repeatedly filtered and cleaned with ion exchange water until the conductivity of the filtrate is 50 μs/cm (cleaning step).

Sequentially, the fused particles separated out after the final filtering operation is dried using a vacuum dryer until the water content of the particles is below 1.0 mass % to obtain a dried toner (drying step).

Then, 2 parts by mass of hydrophobic silica and 0.5 parts by mass of titanium oxide are added in the dried toner and then mixed with a Henschel mixer (external addition step).

The toner of comparative example 3 is obtained through the operation above. The finally obtained toner has a volume mean diameter (50% D) of 115 μm and a BET specific surface area of 0.13 m̂2/g.

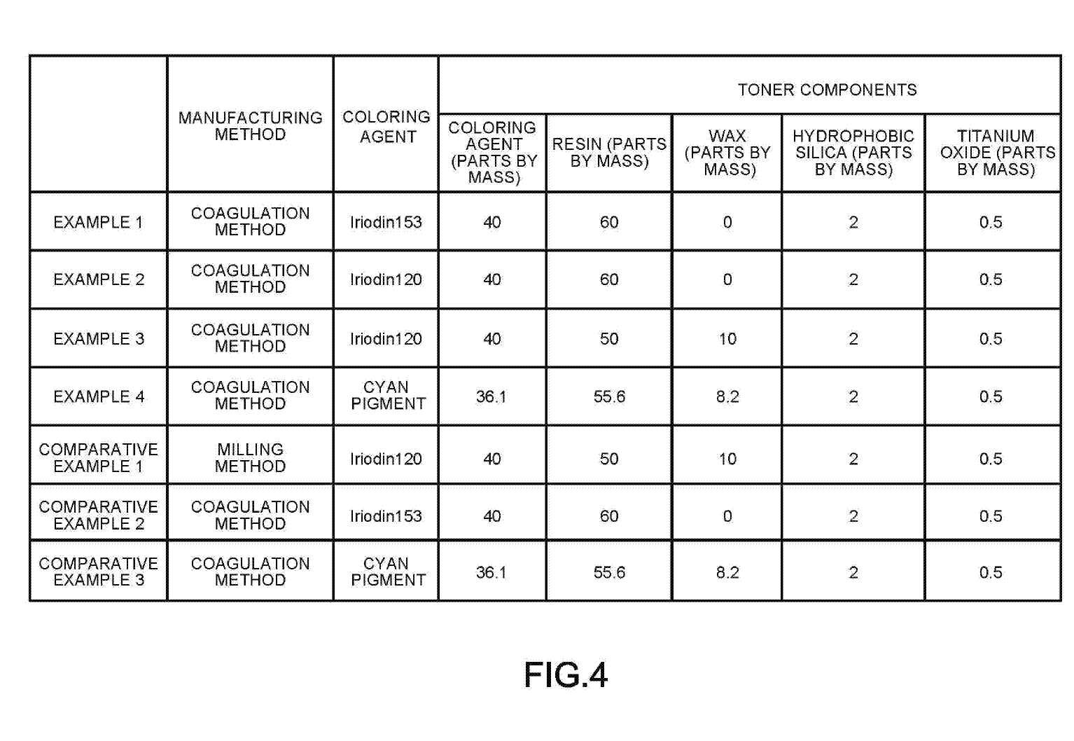

FIG. 4 is a diagram illustrating the components of the toners manufactured in all the examples.

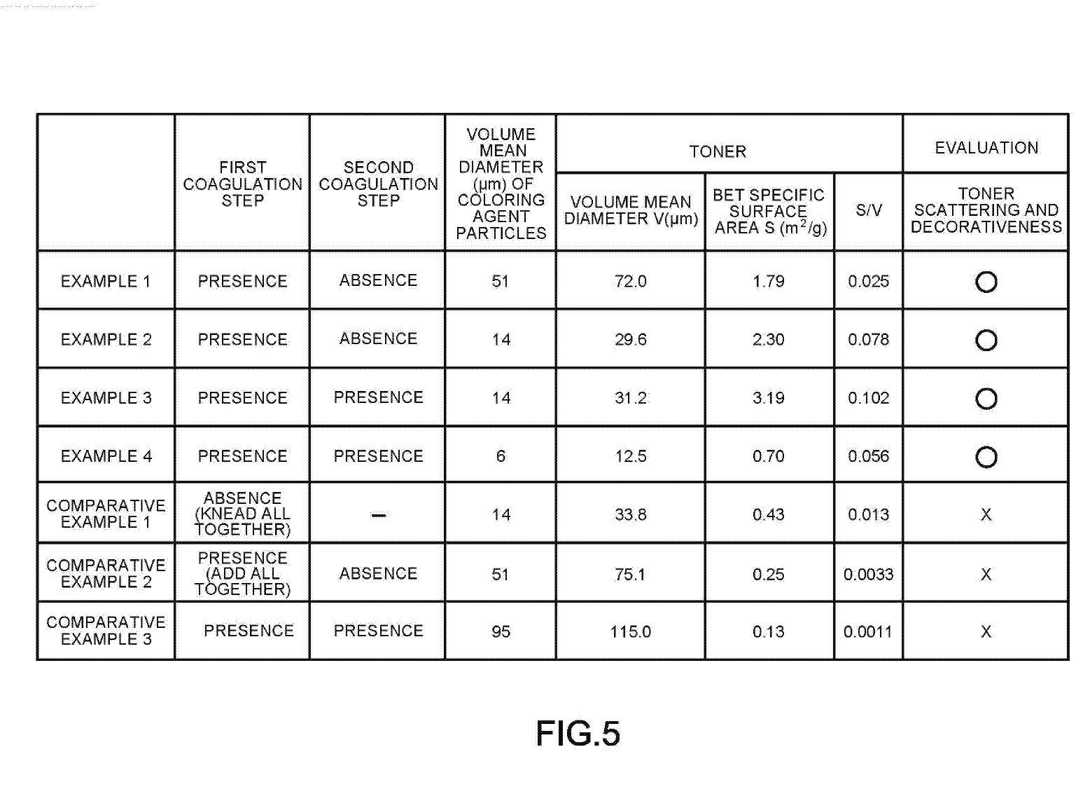

FIG. 5 is a diagram illustrating the results of evaluations on the toners obtained in examples 1-4 and comparative examples 1-3.

In comparative example 1, the coloring agent particles manufactured using a milling method as a toner manufacturing method are not coated by the resin (more than 50% of the surface of the coloring agent particles is not coated by the resin).

In comparative example 2, as the toner manufacturing method, although a coagulation method is used, the resin dispersion is not added in the coloring agent dispersion for a long time in a small amount. Thus, the coloring agent particles are not coated by the resin (more than 50% of the surface of the coloring agent particles is not coated by the resin).

In comparative example 3, as the toner manufacturing method, a coagulation method is used, and the coloring agent particles, although coated by resin, are large in volume mean diameter V and small in BET specific surface area.

In each of comparative examples 1-3, the ratio (S/V) of the BET specific surface (m̂2/g) to the volume mean diameter V (μm) of the toner is below 0.015, thus, the evaluations on the toner scattering and the decorativeness are both poor.

On the other hand, in each of examples 1-4 applied to the present invention, the toner hardly scatters while an adequate decorativeness can be achieved, thus obtaining a good result in examples 1-4.

While certain embodiments have been described these embodiments have been presented by way of example only, and are not intended to limit the scope of the inventions. Indeed, the novel embodiments described herein may be embodied in a variety of other forms: furthermore various omissions, substitutions and changes in the form of the embodiments described herein may be made without departing from the spirit of the inventions. The accompanying claims and there equivalents are intended to cover such forms or modifications as would fall within the scope and spirit of the invention.

What is claimed is:

1. A method for manufacturing an electrophotographic toner, the method comprising:
a coloring agent dispersion preparation step of treating coloring agent particles having a volume mean diameter of above 6 μm with a cationic surfactant,
a resin dispersion (p1) preparation step of treating resin comprising resin particles with an anionic surfactant to obtain a resin dispersion (p1), and
a first coagulation step of adding the resin dispersion (p1) in the coloring agent dispersion to obtain the electrophotographic toner comprising a fused product of an aggregate of the resin particles and the coloring agent particles,
the ratio (S/V) of the BET specific surface area S (m²/g) of the electrophotographic toner to the volume mean diameter V (μm) of the electrophotographic toner being above 0.015.

2. The method for manufacturing the electrophotographic toner according to claim 1, wherein
in the first coagulation step, the resin dispersion (p1) is continuously added in the coloring agent dispersion.

3. The method for manufacturing the electrophotographic toner according to claim 1, comprising:
a second coagulation step of adding a resin-containing resin dispersion (p2) after the first coagulation step is carried out to obtain an aggregate.
